(19) United States
(12) Patent Application Publication
(10) Pub. No.: US 2006/0104245 A1
(43) Pub. Date: May 18, 2006

(54) Wireless device tracking system

(75) Inventors: Chandrasekhar Narayanaswami, Wilton, CT (US); Mandayam Thondanur Raghunath, Fishkill, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 10/986,603

(22) Filed: Nov. 12, 2004

(51) Int. Cl. H04Q 7/00

(52) U.S. Cl. 370/332

(57) ABSTRACT

A method of tracking a wireless device comprising a wireless interface, the method comprises locating a first access point providing a threshold signal strength; sending an association request to the first access point; recording a network address for the first access point; suspending normal operation of the wireless device for a length of time; resuming operation of the wireless device periodically to determine whether the access point still provides the threshold signal strength; and if it is determined that the first access point no longer provides the threshold signal strength and a second access point provides the threshold signal strength, sending a subsequent association signal to the second access point; receiving the network address of the second access point, recording a network address of the second access point, and suspending normal operation.

### CROSS-REFERENCE TO RELATED APPLICATIONS

Not Applicable.

### STATEMENT REGARDING FEDERALLY SPONSORED-RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of information technology, and more particularly relates to the field of locating wireless electronic devices.

### BACKGROUND OF THE INVENTION

Wireless tracking devices are known, however present wireless tracking devices are practically limited due to the short battery life. Modern wireless communication protocols such as IEEE 802.11 offer an opportunity for base stations or access points to track the locations of mobile devices having the appropriate interfaces (e.g., Wi-Fi interface) to a reasonable degree of accuracy. WiFi cell sizes are typically quite small. It is possible to track mobile devices to a reasonable degree of accuracy by just determining the closest WiFi access point to each mobile device. There thus is a need for novel ways to use the IEEE 802.11-based location tracking (or equivalent networks) that are power-efficient and privacy preserving.

### SUMMARY OF THE INVENTION

A method of tracking a wireless device comprising a wireless interface, the method comprises locating a first access point providing a threshold signal strength; sending an association request to the first access point; recording a network address for the first access point; suspending normal operation of the wireless device for a length of time; resuming operation of the wireless device periodically to determine whether the access point still provides the threshold signal strength; and if it is determined that the first access point no longer provides the threshold signal strength and a second access point provides the threshold signal strength, sending a subsequent association signal to the second access point; receiving the network address of the second access point, recording a network address of the second access point, and suspending normal operation.

In another embodiment of the present invention, an information handling system for tracking a wireless device is disclosed. The information handling system includes a processor configured for locating a first access point providing a threshold signal strength, sending an association request to the first access point and recording a network address for the first access point. The processor is further configured for suspending normal operation of the wireless device for a length of time and resuming operation of the wireless device periodically to determine whether the access point still provides the threshold signal strength. The processor is further configured for sending a subsequent association signal to the second access point, if it is determined that the first access point no longer provides the threshold signal strength and a second access point provides the threshold signal strength and receiving the network address of the second access point, recording a network address of the second access point, and suspending normal operation. The information handling system further includes a memory for storing the network addresses of each access point with which the wireless device is associated and a wireless interface for communicating with each access point.

In another embodiment of the present invention, a computer readable medium comprising program instructions for locating a first access point providing a threshold signal strength is disclosed. The computer readable medium comprises program instructions for sending an association request to the first access point, recording a network address for the first access point and suspending normal operation of the wireless device for a length of time. The computer readable medium further comprises program instructions for resuming operation of the wireless device periodically to determine whether the access point still provides the threshold signal strength and sending a subsequent association signal to the second access point, if it is determined that the first access point no longer provides the threshold signal strength and a second access point provides the threshold signal strength. The computer readable medium further comprises program instructions for receiving the network address of the second access point, recording a network address of the second access point, and suspending normal operation.

### BRIEF DESCRIPTION OF THE DRAWINGS

FIG. 1 is a block diagram of a wireless network using tracking technology according to an embodiment of the invention.

FIG. 2 is an illustration of an information processing system according to an embodiment of the present invention.

FIG. 3 is a flow chart illustrating a method according to an embodiment of the present invention.

FIG. 4 is a flow chart illustrating a method according to an embodiment of the present invention.

FIG. 5 is a high level block diagram showing an information processing system useful for implementing one embodiment of the present invention

### DETAILED DESCRIPTION

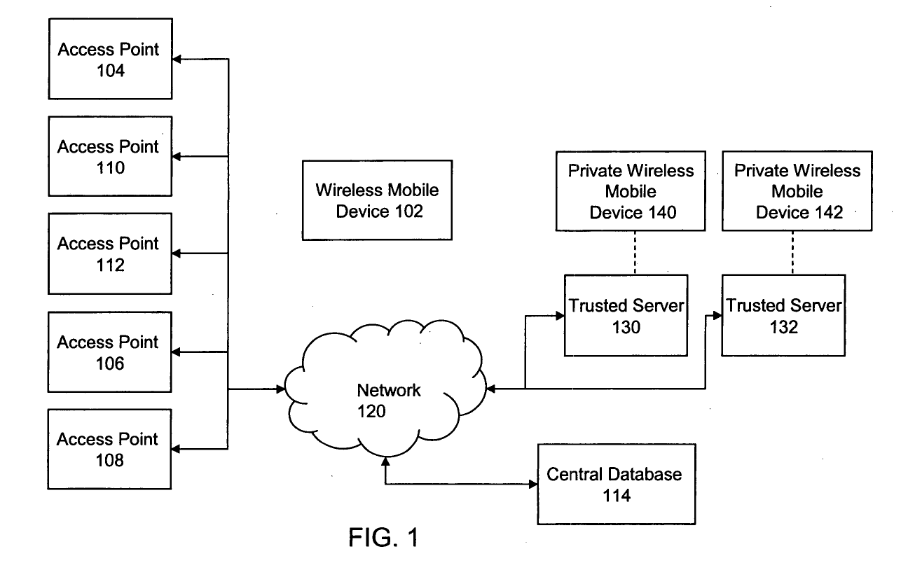

FIG. 1 is a block diagram of a wireless network 100 using a tracking technology according to an embodiment of the invention. The network 100 comprises a wireless mobile device 102, access points 104-112 and a central database 114 and preferably operates under the IEEE 802.11 protocol (also known as the WiFi protocol). In the preferred embodiment, the device 102 is a bracelet that is worn by a user while moving around within the network 100. While wireless device 102 moves within the network 100 the access points (APs, represented by access points 104-112) keep track of its location by storing its access requests preferably at a central database 114, which can be a wireless access point itself or a dedicated database connected to the other nodes in the network 100.

FIG. 1 further shows that access points 104, 110, 112, 106 and 108 are connected to network 120. Further, trusted servers 130 and 132 and central database 114 are connected to the network 120, as they are accessible from multiple access points. In an embodiment of the present invention, the network 120 is a circuit switched network, such as the Public Service Telephone Network (PSTN). In another embodiment, the network 120 is a packet switched network. The packet switched network is a wide area network (WAN), such as the global Internet, a private WAN, a local area network (LAN), a telecommunications network or any combination of the above-mentioned networks. In yet another embodiment, the network 120 is a wired network, a wireless network, a broadcast network or a point-to-point network.

Trusted servers 130 and 132 represent nodes on the wireless network 120 that provide access for wireless mobile devices. Trusted servers provide privacy preserving location tracking services for mobile devices. Privacy preserving means that only people authorized to learn the location of the mobile device will be permitted to find out its current location or history of movements. In one embodiment of the present invention, a wireless mobile device 140 engages in a trust relationship with a trusted server 130 and a wireless mobile device 142 engages in a trust relationship with a trusted server 132.

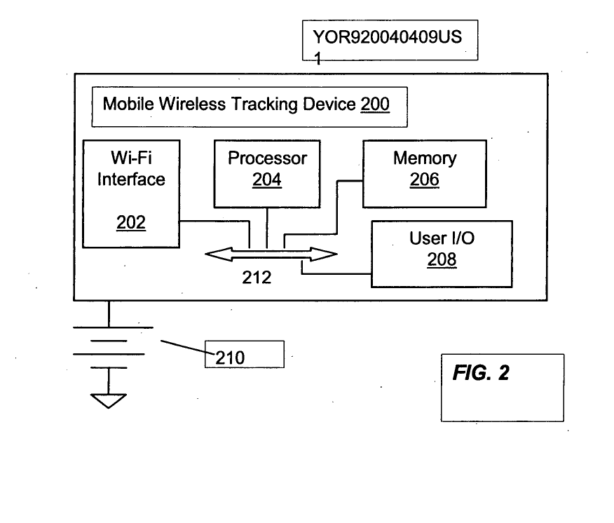

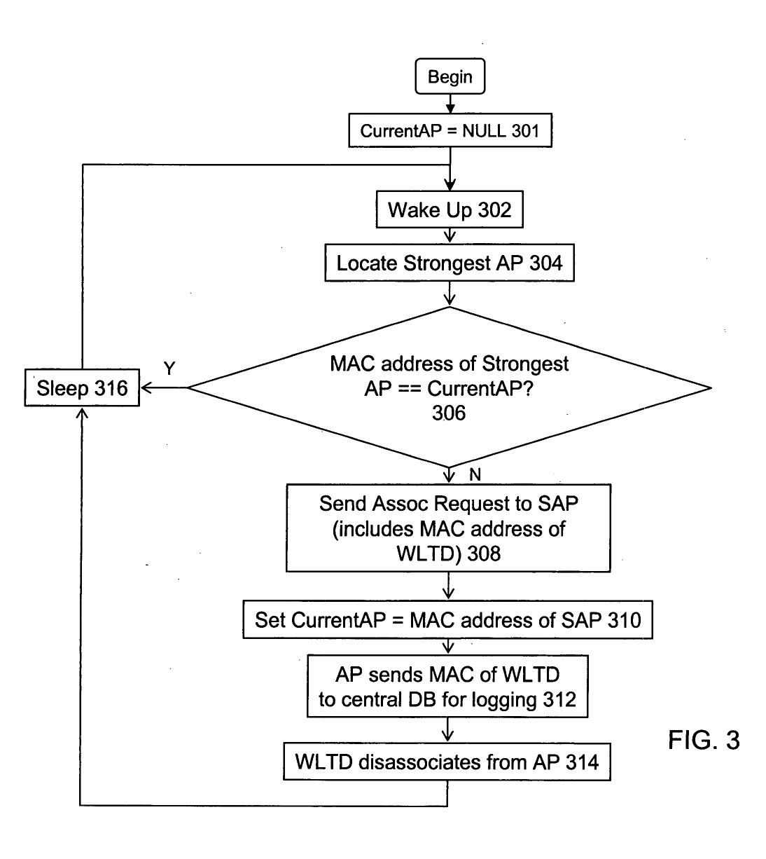

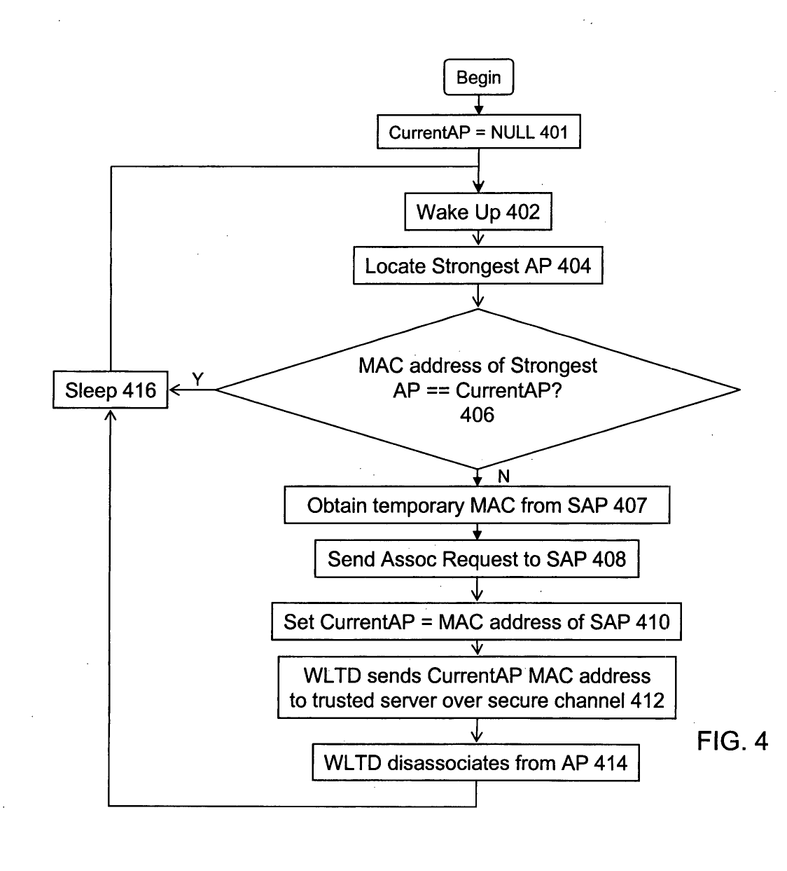

FIG. 2 is an illustration of a wireless device 200 according to an embodiment of the present invention. The wireless device 200 depicts the wireless mobile device 102 of FIG. 1. The wireless device 200 comprises a wireless network interface 202, a processor 204, a memory 206, and at least one user input-output interface 208, all of which are coupled to each other via a bus 212. In this embodiment the network interface 202 is compliant with the WiFi protocol. The processor 204 is configured (i.e., hardwired or programmed) to perform various steps discussed with respect to a method illustrated in FIGS. 3-4. The memory 206 can be a random access memory, a mass storage device (such as a had disk drive) or other suitable storage device. The user I/O 208 can be any of several I/O devices such as a keypad or voice interface.

What has been shown and discussed is a highly-simplified depiction of a programmable computer apparatus. Those skilled in the art will appreciate that other low-level components and connections are required in any practical application of a computer apparatus.

FIG. 3 is a flow chart illustrating a method according to an embodiment of the present invention. FIG. 3 shows the method by which a wireless device interacts with access points. In step 301, the access point association function is initialized and in step 302, the wireless device 102 is activated or woken up. In step 304, the wireless device 102 locates the access point with strongest signal (SAP). Alternatively, the device 102 may check for a threshold level of signal and request association with any AP providing such a level of signal. Referring to FIG. 1, in this case the strongest signal may originate from AP 104 because its the closest access point to device 102.

In step 306 the device 102 determines whether the AP 104 still provides the strongest signal. If the AP 104 still provides the strongest signal (because the device 102 has not moved and AP 104 is still the closest access point), the device 102 resumes its sleep state in step 316. The sleep state is preferably accomplished by turning off the wireless interface and/or other energy-consuming component. The duty cycle is maintained at a low level (i.e., a few milliseconds of transmit time for every five minutes or so of receive-only time) to reduce power consumption.

If the mobile device 102 has moved to an access point that is closer to the device 102, then decision 306 determines that another AP 106 presently provides the strongest signal because the mobile device 102 has moved closer to AP 106. Subsequently, control flows to step 308. In step 308 the device 102 sends an association request to the SAP (AP 106). AP 106 responds by establishing a communication link (association) with the mobile device 102. In step 310, the device 102 records the network address (e.g., the message authentication code or MAC address) for the AP 106. In step 312, the AP 106 sends the MAC address of mobile device 102 to the central database 114 for logging. In step 314, the wireless device disassociates from the AP 106 and goes to sleep in step 316. Subsequently, step 302 is executed when the device wakes up.

One drawback with the above scheme is that the wearer effectively advertises his or her location to the network infrastructure all the time. Some persons do not find this desirable. Therefore, there is a need for a tracking solution that preserves privacy. A solution is to use the proposed ability to request a temporary MAC address from access points. Thus, a mobile wireless device can request a temporary MAC address from an access point and request association. Thus, the access point does not have enough information to identify the wearer of the device. However, the device can identify an access point form the received MAC address of the access point.

The temporary MAC address scheme is described in more detail below. If two nodes in a WiFi network use the same MAC address, this results in a collision and neither device will be able to communicate. Thus, this situation must be avoided using the temporary MAC address scheme. The scheme begins with the bracelet picking a random MAC address, which is then sent in a request to the strongest AP, requesting the AP to assign the bracelet a temporary MAC address. The random address is chosen from a pool that is reserved for temporary MAC address requests, so that the only possibility of a collision is when two bracelets pick the same MAC address for this initial request, which is assumed to be very rare.

In response to the request for a MAC address, the AP assigns the bracelet a MAC address from a pool of MAC addresses it manages. The bracelet accepts this address and uses the AP-assigned MAC address in subsequent communication, such as the actual association request or any other network transfers that the bracelet must execute via the AP. When the bracelet disassociates, it returns the AP-assigned MAC address back to the AP so that the AP can assign the same address to another device at a later time. In this scheme, the bracelet is totally anonymous to the AP since the bracelet does not send any identifier to the AP that the AP can use to identify the bracelet. In all of its communications, the AP uses its own unique MAC address, so the bracelet knows the identity of the AP.

Therefore, while there has been described what is presently considered to be the preferred embodiment, it will be understood by those skilled in the art that other modifications can be made within the spirit of the invention. Once the mobile device associates with the access point it communicates with a trusted server in the network, preferably over a secure encrypted channel and tells the server its own identity and MAC address of the associated access point. For example, device 140 communicates with server 130 and device 142 communicates with server 132. Each user can have its own independent trusted server. The trusted server can query the AP infrastructure and determine the locations of all APs and maintain a table by MAC address of the AP so that the trusted server has the ability to locate the user. Only parties identified to the server by the user (i.e., trusted parties) can obtain the user's location from the server. More detail is provided on the privacy preserving tracking scheme below.

FIG. 4 is a flow chart illustrating a method according to an embodiment of the present invention. FIG. 4 shows the method by which a wireless device interacts with access points while adhering to a privacy preserving tracking scheme. In step 401, the access point association function is initialized and in step 402, the private wireless device 140 is activated or woken up. In step 404, the wireless device 140 locates the access point with strongest signal (SAP). Referring to FIG. 1, in this case the strongest signal may originate from AP 104 because its the closest access point to device 102.

In step 406 the device 140 determines whether the AP 104 still provides the strongest signal. If the AP 104 still provides the strongest signal (because the device 140 has not moved and AP 104 is still the closest access point), the device 140 resumes its sleep state in step 416. If the mobile device 140 has moved to an access point that is closer to the device 140, then decision 406 determines that another AP 106 presently provides the strongest signal because the mobile device 140 has moved closer to AP 106. Subsequently, control flows to step 407.

In step 407, a temporary MAC address is obtained by the device 140 from AP 106. The temporary MAC address scheme is described in greater detail above. In step 408 the device 140 sends an association request to the SAP (AP 106). AP 106 responds by establishing a communication link (association) with the mobile device 140. In step 410, the device 140 records the network address (e.g., the message authentication code or MAC address) for the AP 106.

In step 412, the device 140 sends the MAC address to a trusted server, such as trusted server 130, over a secure channel for logging. In step 414, the wireless device disassociates from the AP 106 and goes to sleep in step 416. Subsequently, step 402 is executed when the device wakes up.

Optionally, other power-saving techniques can be applied on top of the above scheme. According to one enhancement, when a mobile device associates with an AP, based on local conditions, the AP can tell the mobile device to go to a low-energy-consumption (sleep) mode for a long period of time. For example, if a truck carrying set of goods are leaving a dock and the AP near the dock knows that it will take three days for the truck to reach the destination, the AP could tell the mobile device to sleep for three days before determining whether another AP is near. In another example, the length of time the mobile device sleeps can be specified by the access point at association time, can be specified by a user of the wireless device using a dial or other interface or can be determined by an algorithm that bases the decision on motion information received from a motion detector (such as an accelerometer or a flywheel) coupled with the wireless device. The motion detector can inform the device when there is movement. If there is no movement, the device can use this information to extend its sleep interval.

Because the device 102 transmits only when it moves near a new access point, it minimizes the amount of energy required to transmit, to times it actually moves. By querying a few access points the history of locations where the device 102 associated with an access point the location of the device 102 can be determined. Tracking the location of various devices/bracelets can be simultaneously accomplished.

Almost any piece of equipment that has a WiFi interface for its normal operation can be converted to a trackable device by installing a software program that controls operation of the host device to work in a power-saving mode to extend the range in which a device can be tracked.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

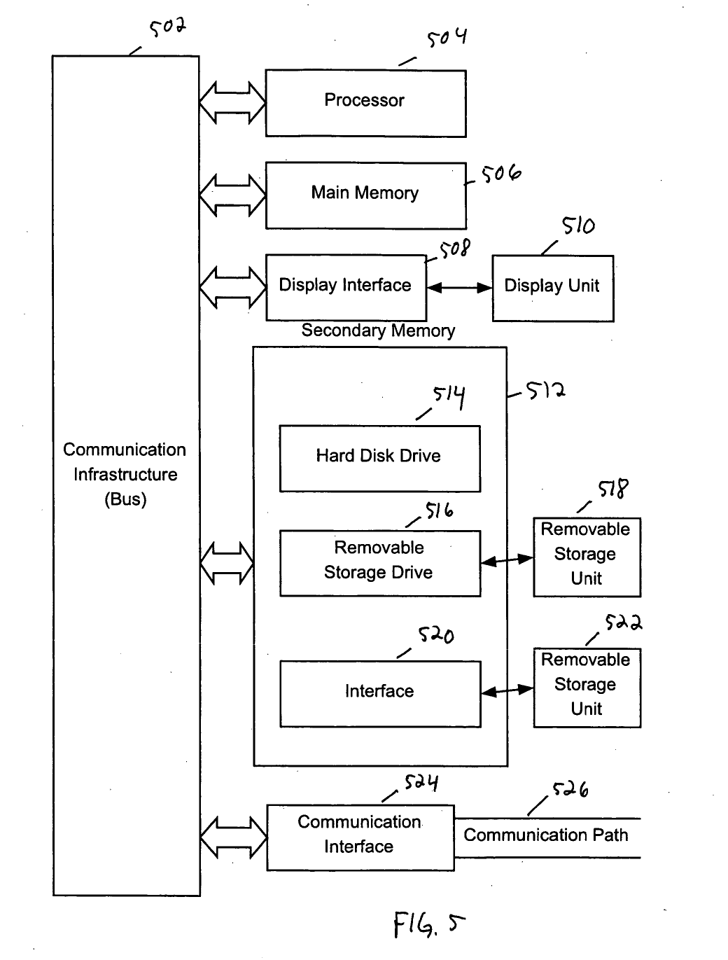

FIG. 5 is a high level block diagram showing an information processing system useful for implementing one embodiment of the present invention. The computer system includes one or more processors, such as processor 504. The processor 504 is connected to a communication infrastructure 502 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 508 that forwards graphics, text, and other data from the communication infrastructure 502 (or from a frame buffer not shown) for display on the display unit 510. The computer system also includes a main memory 506, preferably random access memory (RAM), and may also include a secondary memory 512. The secondary memory 512 may include, for example, a hard disk drive 514 and/or a removable storage drive 516, representing a floppy disk drive, a magnetic tape drive, an optical disk drive, etc. The removable storage drive 516 reads from and/or writes to a removable storage unit 518 in a manner well known to those having ordinary skill in the art. Removable storage unit 518, represents a floppy disk, a compact disc, magnetic tape, optical disk, etc. which is read by and written to by removable storage drive 516. As will be appreciated, the removable storage unit 518 includes a computer readable medium having stored therein computer software and/or data.

In alternative embodiments, the secondary memory 512 may include other similar means for allowing computer programs or other instructions to be loaded into the computer system. Such means may include, for example, a removable storage unit 522 and an interface 520. Examples of such may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to the computer system.

The computer system may also include a communications interface 524. Communications interface 524 allows software and data to be transferred between the computer system and external devices. Examples of communications interface 524 may include a modem, a network interface (such as an Ethernet card), a communications port, a PCMCIA slot and card, etc. Software and data transferred via communications interface 524 are in the form of signals which may be, for example, electronic, electromagnetic, optical, or other signals capable of being received by communications interface 524. These signals are provided to communications interface 524 via a communications path (i.e., channel) 526. This channel 526 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 506 and secondary memory 512, removable storage drive 516, a hard disk installed in hard disk drive 514, and signals. These computer program products are means for providing software to the computer system. The computer readable medium allows the computer system to read data, instructions, messages or message packets, and other computer readable information from the computer readable medium.

Computer programs (also called computer control logic) are stored in main memory 506 and/or secondary memory 512. Computer programs may also be received via communications interface 524. Such computer programs, when executed, enable the computer system to perform the features of the present invention as discussed herein. In particular, the computer programs, when executed, enable the processor 504 to perform the features of the computer system. Accordingly, such computer programs represent controllers of the computer system.

What has been shown and discussed is a highly-simplified depiction of a programmable computer apparatus. Those skilled in the art will appreciate that other low-level components and connections are required in any practical application of a computer apparatus.

Therefore, while there has been described what is presently considered to be the preferred embodiment, it will be understood by those skilled in the art that other modifications can be made within the spirit of the invention.

What is claimed is:

1. A method of tracking a wireless device comprising a wireless interface, the method comprising:
locating a first access point providing a threshold signal strength;
sending an association request to the first access point;
recording a network address for the first access point;
suspending normal operation of the wireless device for a length of time;
resuming operation of the wireless device periodically to determine whether the access point still provides the threshold signal strength; and
if it is determined that the first access point no longer provides the threshold signal strength and a second access point provides the threshold signal strength, sending a subsequent association signal to the second access point; receiving the network address of the second access point, recording a network address of the second access point, and suspending normal operation.

2. The method of claim 1, wherein the threshold signal strength is the strongest signal strength received from among a plurality of access points.

3. The method of claim 1, wherein suspending normal operation comprises turning off the wireless interface of the wireless device.

4. The method of claim 1 wherein the wireless device is a wearable bracelet.

5. The method of claim 1 further comprising recording a time stamp associated with receiving the network address of the second access point.

6. The method of claim 1 wherein the wireless interface is a WiFi interface.

7. The method of claim 1 wherein the network addresses of the first and second access points are MAC addresses.

8. The method of claim 1 wherein the wireless device operates on a low duty cycle.

9. The method of claim 1 further comprising receiving a temporary MAC address from the first access point before sending an association request and including the temporary MAC address in the association request to the first access point.

10. The method of claim 9 further comprising using an encrypted channel to communicate with a trusted server in the network after associating with the first access point.

11. The method of claim 10, further comprising sending location information of the wireless device to the trusted server, wherein the location information is revealed only to the trusted server.

12. The method of claim 1, wherein the element of suspending comprises:
suspending normal operation of the wireless device for a length of time that is specified by the access point.

13. The method of claim 1, wherein the element of suspending comprises:
suspending normal operation of the wireless device for a length of time that is specified via an interface by a user of the wireless device.

14. The method of claim 1, wherein the element of suspending comprises:
suspending normal operation of the wireless device for a length of time that is determined using motion information received from a motion detector coupled with the wireless device.

15. An information handling system, comprising:
a processor configured for:
locating a first access point providing a threshold signal strength;
sending an association request to the first access point;
recording a network address for the first access point;
suspending normal operation of the wireless device for a length of time;
resuming operation of the wireless device periodically to determine whether the access point still provides the threshold signal strength; and
if it is determined that the first access point no longer provides the threshold signal strength and a second access point provides the threshold signal strength, sending a subsequent association signal to the second access point; receiving the network address of the second access point, recording a network address of the second access point, and suspending normal operation; and
a memory for storing the network addresses of each access point with which the wireless device is associated; and
a wireless interface for communicating with each access point.

16. A computer readable medium comprising program instructions for locating a first access point providing a threshold signal strength, the program instructions including instructions for:
sending an association request to the first access point;
recording a network address for the first access point;
suspending normal operation of the wireless device for a length of time;
resuming operation of the wireless device periodically to determine whether the access point still provides the threshold signal strength; and
if it is determined that the first access point no longer provides the threshold signal strength and a second access point provides the threshold signal strength, sending a subsequent association signal to the second access point; and
receiving the network address of the second access point, recording a network address of the second access point, and suspending normal operation.
